(19) United States
(12) Patent Application Publication
(10) Pub. No.: US 2021/0168910 A1
(43) Pub. Date: Jun. 3, 2021

(54) ELECTRIC LIQUID-HEATING DEVICE, AND USE OF SAME AND OF A HEAT CONDUCTOR

(71) Applicant: Webasto SE, Stockdorf (DE)

(72) Inventors: CHRISTOPH JÖRG, Stockdorf (DE); VOLODOMYR ILCHENKO, Stockdorf (DE); VITALI DELL, Stockdorf (DE); NIKOLAUS GERHARDT, Stockdorf (DE); BENGT MEIER, Stockdorf (DE); MICHAEL SCHWANECKE, Stockdorf (DE); MARTIN ZOSKE, Stockdorf (DE)

(21) Appl. No.: 16/615,049

(22) PCT Filed: May 23, 2018
(86) PCT No.: PCT/EP2018/063499

§ 371 Date: Nov. 19, 2019

(30) Foreign Application Priority Data
May 24, 2017 (DE) 10 2017 111 373.8
May 24, 2017 (DE) 10 2017 111 378.9
Jul. 6, 2017 (DE) 10 2017 115 148.6
Sep. 12, 2017 (DE) 10 2017 121 064.4

(51) Int. Cl. H05B 3/82; H05B 3/14; H05B 1/02

(52) U.S. Cl. CPC H05B 3/82; H05B 3/146; H05B 1/0236; H05B 2214/04; H05B 2203/003; H05B 2203/02; H05B 2203/021

(57) ABSTRACT

An electrical fluid heater, in particular water heater, preferably for a motor vehicle, including at least one fluid accommodating container and at least one heating conductor having a conductive polymer structure, for heating fluid, in particular water, accommodated in the fluid accommodating container.

### CROSS-REFERENCE TO RELATED APPLICATIONS

This application represents the national stage entry of PCT International Patent Application No. PCT/EP2018/063499 filed on May 23, 2018 and claims priority to German Patent Application No. DE 10 2017 111 373.8 filed May 24, 2017, German Patent Application No. DE 10 2017 111 378.9 filed May 24, 2017, German Patent Application No. DE 10 2017 115 148.6 filed Jul. 6, 2017, and German Patent Application No. DE 10 2017 121 064.4 filed Sep. 12, 2017. The contents of each of these applications are hereby incorporated by reference as if set forth in their entirety herein.

### Description

The disclosure relates to an electrical fluid heater, in particular water heater, preferably for a motor vehicle.

Electrical water heaters (in particular those used in mobile applications) are usually based on ceramic heating elements having a comparatively highly temperature-dependent electrical resistance, which enables self-regulation of the heat output. These resistors are usually PTC elements (PTC stands for Positive Temperature Coefficient). A PTC element comprises a PTC thermistor, that is to say a temperature-dependent resistor having a positive temperature coefficient, which conducts the electric current better at low temperatures than at high temperatures. Also known are electrical water heaters based on so-called wire heaters, which are generally connected to heat exchanger areas.

In conventional water heaters having ceramic PTC elements, production is comparatively complex on account of complicated heat exchanger manufacture and the incorporation of the ceramic elements. Sorting of the ceramic elements is usually necessary on account of manufacturing tolerances. The power density in the heating element/heat exchanger composite assembly is comparatively unsatisfactory on account of local heat generation. A maximum heating power is limited on account of the thickness of the PTC material (or on account of a limited heat dissipation from the ceramic). A small geometric spacing of components having a high voltage potential entails a risk of short circuit. In the case of the abovementioned wire heaters, in turn, a PTC effect is not present and self-regulation is therefore not possible, which is associated with a corresponding safety problem.

It is therefore an object of the disclosure to propose a fluid heater, in particular water heater, which enables the fluid (water) to be heated effectively. In particular, the intention is to enable a high power density in conjunction with a comparatively small structural space.

This object is achieved in particular by means of an electrical fluid heater, preferably water heater, according to claim 1.

In particular, the object is achieved by means of an electrical fluid heater, in particular water heater, preferably for a vehicle, more preferably motor vehicle (such as car or lorry), comprising at least one fluid accommodating container and at least one heating conductor having a conductive polymer structure, for heating fluid, in particular water, accommodated in the fluid accommodating container.

A central concept of the disclosure is to propose an electrical fluid heater (in particular water heater) in which a fluid accommodating container (water container) is provided and the fluid accommodated there (or the water accommodated there) is heated by means of a conductive polymer structure. The heat absorbed in the fluid container can then be made available to further components (in particular in a motor vehicle) in particular by way of a cooling fluid circuit. Overall, efficient heat generation and efficient (direct) heat transfer can be made possible. Overall, safe and efficient heating is made possible. A structural space occupied can be comparatively compact.

The fluid accommodating container preferably comprises a housing and a (at least one) fluid inlet and a (at least one) fluid outlet. The fluid container can have a (maximum) extent of 8 cm or more—or 12 cm or more—in at least two mutually perpendicular directions. The fluid accommodating container can be (at least substantially) a polyhedron or a cylinder (in particular circular cylinder). An area of an entrance and/or exit opening is preferably significantly smaller (for example by a factor of at least 2 or a factor of at least 3) than a wall area of the fluid accommodating container on which the opening is provided.

In one concrete embodiment, the heating conductor is a heating cable (in particular polymer PTC cable). The heating cable can comprise at least one electrical connection (for example an, in particular inner, pair of electrical, preferably metallic, connection conductors). The polymer structure can be provided in a manner adjoining connection elements (in particular surrounding connection wires). Said polymer structure can be embodied such that it is per se cablelike (pliable). A cross section of the polymer structure can for example correspond to a (rounded) rectangle or be embodied such that it is elliptic, optionally round (circular). In particular, a sheathing can be provided around the polymer structure. The sheathing can comprise for example a first (insulating) polymer component (around the conductive polymer structure). The first insulating polymer component can preferably comprise (modified) fluoropolymer. Around the first insulating polymer component, it is in turn optionally possible to provide a (conductive, in particular metallic) sheathing (for example composed of a copper alloy or composed of, preferably stainless, steel) and/or a second insulating polymer component (optionally as outermost sheathing), comprising a (modified) polymer, in particular (modified) polyolefin and/or a fluoropolymer. The electrical connections can be embodied from copper or a copper alloy (optionally nickel-coated).

In general, the heating conductor is preferably shapeable (not dimensionally stable vis-à-vis external forces, such as e.g. bending forces), in particular bendable.

Preferably, the heating conductor is arranged in a meandering fashion (that is to say has at least one bend, preferably at least three or at least five bends). More preferably, the meandering heating conductor can be positioned by guides in the fluid accommodating container (or a corresponding heat exchanger). Overall, an effective heat transfer can be made possible as a result.

The fluid heater is designed in particular for operation in the high-voltage range, but can also be used for the low-voltage range.

High-voltage range should preferably be understood to mean a range of above 100 volts, more preferably more than 400 volts. A low-voltage range should preferably be understood to mean a range of 100 volts, preferably 60 volts.

Preferably, the heating conductor is arranged (directly) in contact with the fluid accommodated in the fluid accommodating container or (at least partly) within the fluid container. As a result, a good heat transfer to the fluid (in particular on account of the direct contact) can be made possible. Direct heat transfer takes place (or no heat transfer takes place by way of additional heat conduction).

In embodiments, the conductive polymer structure comprises an (optionally insulating) polymer component and a conductive carbon component.

The carbon component can be present in particle form and/or as a carbon backbone.

The carbon component can be present in the form of carbon black and/or graphite and/or graphene and/or carbon fibres and/or carbon nanotubes.

The polymer component can be embodied in the form of an electrically insulating polymer component and/or can comprise a first polymer subcomponent based on ethylene acetate or ethylene acetate copolymer and/or ethylene acrylate or ethylene acrylate copolymer and/or a second polymer subcomponent based on polyolefin, in particular polyethylene and/or polypropylene, and/or polyester and/or polyamide and/or fluoropolymer.

The polymer structure is preferably a PTC thermistor. As a result, self-regulation of the heat output can be made possible, which simplifies the control and in particular increases safety during operation.

The object mentioned above is furthermore achieved by means of the use of a fluid heater, in particular water heater, of the above type for heating fluid, in particular water, preferably for a vehicle, more preferably for a motor vehicle, more preferably for a motor vehicle interior (in particular of a car or lorry).

The object mentioned above is furthermore achieved by means of the use of a heating conductor having a conductive polymer structure for heating fluid, in particular water, accommodated in a fluid accommodating container, preferably in a vehicle, more preferably a motor vehicle, more preferably for a motor vehicle interior (in particular of a car and/or lorry).

The conductive polymer structure can be crosslinked by (ionizing or high-energy) radiation, such as α-, β- or, preferably, electron radiation.

The heating conductor or at least the conductive polymer structure is preferably non-dimensionally stable (but can also be embodied as dimensionally stable). A corresponding arrangement of the heating conductor is correspondingly simplified as a result.

The carbon component can be embodied or arranged such that it allows a current flow, e.g. in particle form (with the particles correspondingly touching one another or being close together) and/or as a carbon backbone.

The polymer structure can comprise an electrically insulating polymer component.

The object mentioned above is furthermore achieved by means of a vehicle comprising a fluid heater, in particular water heater, of the type described above or produced according to the method described above.

Polymer component and carbon component are preferably mixed together or interlaced in one another. By way of example, the polymer component can form a (skeletonlike) backbone in which the carbon component is received, or vice versa.

Preferably, the polymer structure comprises at least 5% by weight, preferably at least 10% by weight, even more preferably at least 15% by weight, even more preferably at least 20% by weight and/or less than 50% of carbon (if appropriate without taking into account a carbon fraction of the polymer as such) or of the carbon component, such as e.g. the carbon particles.

Preferably, the carbon component comprises at least 70% by weight of carbon.

In embodiments, the polymer component can comprise a first polymer subcomponent based on ethylene acetate (copolymer) and/or ethylene acrylate (copolymer) and/or a second polymer subcomponent based on polyolefin, in particular polyethylene and/or polypropylene, and/or polyester and/or polyamide and/or fluoropolymer. The term “subcomponent” is intended to be used here in particular for differentiation between first and second polymer subcomponents. The respective subcomponent can form the polymer component either in part or else in full. The ethylene acrylate can be ethyl methyl acrylate or ethylene ethyl acrylate. The ethylene acetate can be ethylene vinyl acetate. The polyethylene can be HD (High Density) polyethylene, MD (Medium Density) polyethylene, LD (Low Density) polyethylene. The fluoropolymer can be PFA (copolymer composed of tetrafluoroethylene and perfluoropropyl vinyl ester), MFA (copolymer composed of tetrafluoroethylene and perfluorovinyl ester), FEP (copolymer composed of tetrafluoroethylene and hexafluoropropylene), ETFE (copolymer composed of ethylene and tetrafluoroethylene) or PVDF (polyvinylidene fluoride).

In embodiments, the first polymer subcomponent can be embodied as described in WO 2014/188190 A1 (as first electrically insulating material). The second polymer subcomponent can likewise be embodied as described in WO 2014/188190 A1 (as second electrically insulating material).

The polymer structure and/or a corresponding substance (e.g. paste) to be shaped for its production can comprise (as, in particular, crystalline binder) at least one polymer, preferably based on at least one olefin; and/or at least one copolymer of at least one olefin and at least one monomer which can be copolymerized therewith, e.g. ethylene/acrylic acid and/or ethylene/ethyl acrylate and/or ethylene/vinyl acetate; and/or at least one polyalkenamer (polyacetylene or polyalkenylene), such as e.g. polyoctenamer; and/or at least one, in particular melt-deformable, fluoropolymer, such as e.g. polyvinylidene fluoride and/or copolymers thereof.

In general, the polymer structure or a substance (paste) used for producing the polymer structure can be embodied as described in DE 689 23 455 T2. This also holds true, in particular, for the production and/or concrete composition thereof. By way of example, this also holds true for possible binders (in particular in accordance with page 4, 2nd paragraph and page 5, 1st paragraph of DE 689 23 455 T2) and/or solvents (in particular in accordance with page 5, 2nd paragraph and page 6, 2nd paragraph of DE 689 23 455 T2).

The polymer structure is preferably a PTC thermistor. As a result, self-regulation of the heat output can be made possible, which simplifies the control and in particular increases safety during operation.

The heating conductor (in particular the heating cable) can preferably be embodied as described in WO 2014/188190 A1.

The term “conductive”, in particular with regard to the polymer structure, should be understood as an abbreviation of “electrically conductive”.

An electrically insulating material should be understood to mean, in particular, a material which has an electrical conductivity of less than 10⁻¹ S·m⁻¹ (optionally less than 10⁻⁸ S·m⁻¹) (at room temperature of, in particular, 25° C.). Accordingly, an electrical conductor or a material (or coating) having electrical conductivity should be understood to mean a material having an electrical conductivity of preferably at least 10 S·m⁻¹, more preferably at least 10³ S·m⁻¹ (at room temperature of, in particular, 25° C.).

Further embodiments are evident from the dependent claims.

The disclosure is described below on the basis of an exemplary embodiment which is explained in greater detail with reference to the accompanying figures, in which:

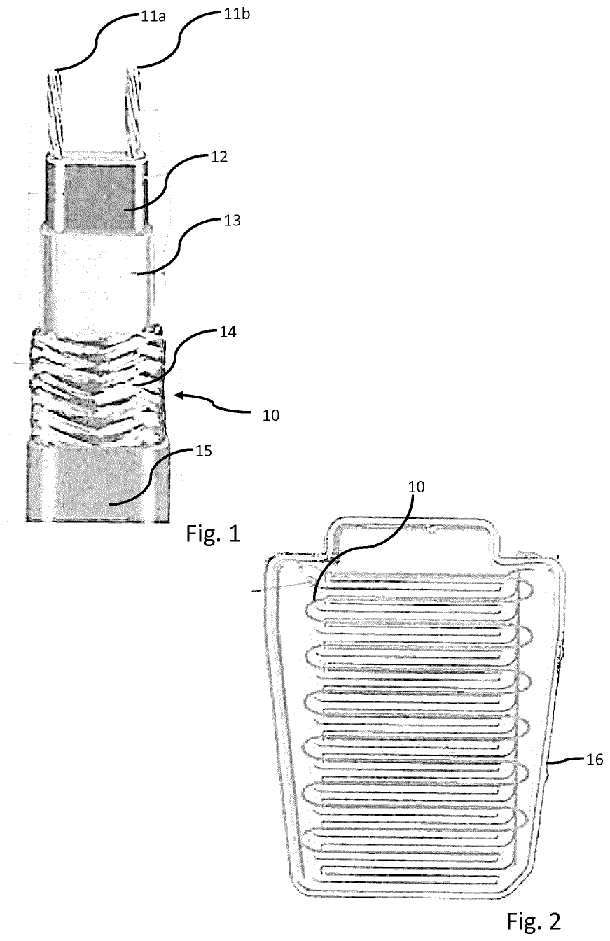

FIG. 1 shows a schematic oblique view of a heating conductor according to the disclosure; and

FIG. 2 shows a schematic view of an electrical water heater according to the disclosure.

In the following description, the same reference signs are used for identical and identically acting parts.

FIG. 1 shows a schematic oblique view (with a partly cut-away view showing internal components) of a heating conductor 10 according to the disclosure.

The heating conductor 10 comprises two electrically conductive (metallic) lines 11a, 11b. The latter are surrounded by a conductive polymer structure 12 or a corresponding polymer core. The polymer structure 12 in turn is surrounded (optionally) by an inner sheath 13 composed of an insulating material (for example polymer, in particular fluoropolymer). The inner sheath 13 is in turn surrounded by a conductive (metallic) sheathing 14. The sheathing 14 is in turn surrounded (optionally) by an outer sheath 15, which is preferably formed from an insulating material, in particular polymer (preferably comprising polyolefin and/or fluoropolymer).

FIG. 2 shows a schematic illustration of an electrical fluid heater (water heater) according to the invention disclosure. It is discernible therein that the heating conductor 10 is arranged in a meandering fashion in a fluid accommodating container 16. For this purpose, corresponding guides can be positioned at a heat exchanger area.

It should be pointed out at this juncture that all parts described above, considered by themselves and in any combination, in particular the details illustrated in the drawings, are claimed as essential to the disclosure. Modifications thereof are familiar to the person skilled in the art.

### LIST OF REFERENCE SIGNS

10 Heating conductor

11a Line

11b Line

12 Polymer structure

13 Inner sheath

14 Sheathing

15 Outer sheath

16 Housing

1. Electrical fluid heater comprising at least one fluid accommodating container and at least one heating conductor having a conductive polymer structure, for heating fluid accommodated in the fluid accommodating container.

2. Fluid heater according to claim 1, wherein the heating conductor is a heating cable.

3. Fluid heater according to claim 1, wherein the heating conductor is arranged in a meandering fashion.

4. Fluid heater according to claim 1, wherein the heating conductor is arranged within the fluid accommodating container.

5. Fluid heater according to claim 1, wherein the polymer structure comprises a polymer component and a carbon component,
wherein the carbon component is present in particle form and/or as a carbon backbone and/or
wherein the carbon component is present in the form of carbon black and/or graphite and/or graphene and/or carbon fibres and/or carbon nanotubes.

6. Fluid heater according to claim 1, wherein the polymer component is embodied in the form of an electrically insulating polymer component and/or comprises a first polymer subcomponent based on ethylene acetate or ethylene acetate copolymer and/or ethylene acrylate or ethylene acrylate copolymer and/or
a second polymer subcomponent based on polyolefin and/or polyester and/or polyamide and/or fluoropolymer.

7. Fluid heater according to claim 1, wherein the polymer structure is a PTC thermistor.

8. A motor vehicle comprising fluid heater according to claim 1.

9. A motor vehicle comprising a heating conductor having a conductive polymer structure for heating fluid accommodated in a fluid accommodating container, preferably in a motor vehicle.

10. Electrical fluid heater according to claim 1, wherein the fluid is water.

11. Fluid heater according to claim 6, wherein the second polymer subcomponent based on polyolefin is polyethylene and/or polypropylene.
